(19) United States
(12) Patent Application Publication
(10) Pub. No.: US 2004/0133441 A1
(43) Pub. Date: Jul. 8, 2004

(54) Method and program for transferring information from an application

(76) Inventors: Jeffrey Brady, Jersey City, NJ (US); Kevin McMurtry, Basking Ridge, NJ (US); Greg Miller, Chesapeake, VA (US)

Correspondence Address: Louis M. Heidelberger, REED SMITH LLP, 2500 One Liberty Place, Philadelphia, PA, 19103-7301, US

(21) Appl. No.: 10/654,591

(22) Filed: Sep. 3, 2003

Related U.S. Application Data
(60) Provisional application No. 60/408,225, filed on Sep. 4, 2002.

(51) Int. Cl. G06F 17/60

(52) U.S. Cl. 705/1

(57) ABSTRACT

The present invention includes a transfer tool for transferring data from a business application to a different application, such as waybill generating software. The process involves integrating a transfer tool with a business application to allow a user of the business application to specify data to be transferred to the different application. The specified data may be tailored to address information required by the different application, such as address information for a waybill generating software tool.

This application claims priority to Provisional Patent Application Serial No. 60/408,225, filed Sep. 4, 2002:

### FIELD OF THE INVENTION

The present invention pertains to the transfer of information from an application, and, more particularly, to the export of grouped information from a business application, preferably in a format compatible with recipient software, through the use of an integrated tool, thereby allowing a user to provide correlation identifiers identifying the manner in which information is grouped in a business application, and thereby allowing an automated acquisition of that information for transfer to a recipient software in a format maintaining value identity, such that the recipient software is enabled to correctly utilize the information.

### BACKGROUND OF THE INVENTION

The tracking and shipping of packages from one location to another is critical in many business endeavors. To this end, various package shipping services, such as Federal Express, United Parcel Service, and the United States Postal Service, have been created to allow businesses to rapidly ship small packages to diverse destinations. These shipping services use standardized systems to allow the efficient receipt, routing, shipping, and delivery of packages. An initial step in the shipping of a package is typically the completion of a waybill, identifying the shipper and recipient of the package, as well as other information required for the transport of the package.

In order to provide for simplified preparation of waybills, shippers may provide custom software for the preparation of waybills. The information contained on the waybill may include values determined by proprietary functions, such as determinations of routing, calculation of shipping expenses, or other factors determined by the shipping service. Such shipping tools may query a user to provide specific information regarding a package and destination in order to generate an appropriate shipping label. Simple information, such as a street address or zip code, may be utilized to generate routing information, or to generate machine-readable labeling for a package, such as bar code labels. The waybill software typically is written in accordance with the goals of the shipping service, and thus may not incorporate functions desirable to businesses.

Companies using the shipping services typically use computer programs other than the waybill software for conducting business functions, such as assembling lists of recipients for a package. Small businesses desiring to avoid the expense of customized business software may utilize off the shelf software to accomplish such functions. For example, a small business may use a spreadsheet to generate a list of recipients, using tools associated with the spreadsheet to organize recipients according to business purposes. For example, a business may desire to organize recipients by destination state. More involved businesses may utilize off the shelf database programs to provide greater indexing of the data.

The disconnect between waybill software and business applications, such as spreadsheets, requires an operator to manually transfer data from the business application to the waybill software. This manual transfer is inefficient to small businesses, which may be particularly sensitive to labor requirements. Accordingly, the ability to reduce the effort required to transfer shipping information from business applications to waybill software may be important to small businesses. Although the benefit may be profound for small businesses, reducing the difficulty involved in such a transfer may also be important for any businesses requiring the transfer of information from business applications to waybill software.

Although the present invention is described in the context of shipping software, the ability to export information from business applications such that the information is co-textually compatible with recipient software extends beyond shipping software applications. For example, check generating software may also require the exporting of data from a business application. Thus, the present invention is not limited to exporting data for shipping software.

### SUMMARY OF THE INVENTION

The present invention includes a transfer tool for transferring data from a business application to a different application, such as waybill generating software. The process involves integrating a transfer tool with a business application to allow a user of the business application to specify data to be transferred to the different application. The specified data may be tailored to address information required by the recipient application, such as address information for a waybill generating software tool.

The present invention may be embodied in a method for transferring information from a business application operating on a business application computer to recipient software. The information may include a plurality of records utilized in association with the business application, wherein each record has more than one value associated with the record. The values associated with each record may be organized by value types. The method may include the steps of instantiating a transfer tool on the business application computer, querying a user of the transfer tool for identifiers identifying value types desired to be transferred to the recipient software, receiving from the user a plurality of identifiers identifying value types to be transferred, acquiring from the business application values to be transferred in accordance with the identifiers, and exporting the values to be transferred in a format which can be received by the recipient software either directly or indirectly.

The present invention may also be embodied in software for exporting information from a business application. The information may consist of multiple records, each recording having several common value types associated with the record. The software, when executed on a computer, may first instantiate a transfer tool on the computer on which the software has been installed. The transfer tool may include a textbox displaying information types to be transferred from the business application, query boxes within the textbox for a user to identify correlating values between the manner in which the information is organized in the business application, and controls for utilizing the transfer tool. The presence of the query boxes may prompt a user to provide correlating values. Once the user has provided the correlating values, the software may acquire information to be transferred from the business application, and export the information from the business application to recipient software, or to an intermediate storage location.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in typical computing applications, networks and systems. Those of ordinary skill in the art will recognize that other elements are desirable and/or required in order to implement the present invention. The manner in whichever, because such elements are well known in the art, and because they do not facilitate a better understanding of the present invention, a discussion of such elements is not provided herein. The disclosure herein is directed to all such variations and modifications to the applications, networks, and systems, as disclosed herein and as will be known, or apparent, to those skilled in the art.

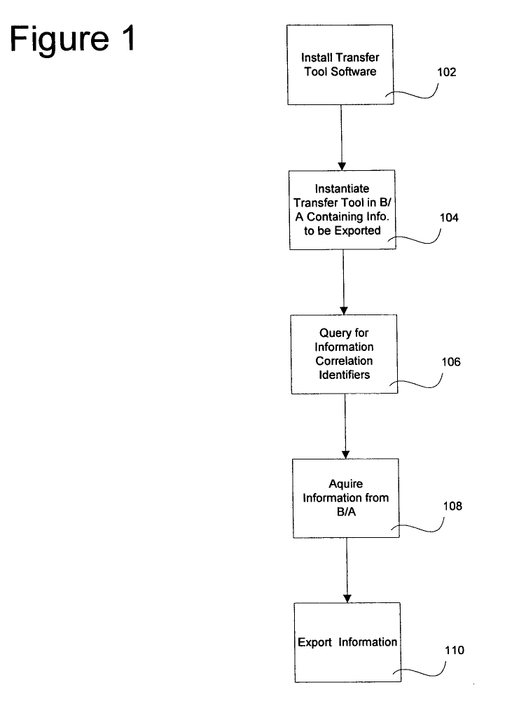

With respect to FIG. 1, wherein like numbers represent like elements, there is shown a flowchart associated with the present invention. The invention is directed to improving the ability of those responsible for shipping materials, such as through an express package service, to improve information transfer between existing business tools and recipient software. Although waybill software is used as recipient software for the purpose of illustration herein, the recipient software may be any software to which it is desired to transfer information, including, but not limited to, document generating software, document management software, document addressing or mailing software, check generating software, or any other software application that may be used wherein a business application is used to prepare data for the software application. The description of the present invention in the context of a business application and waybill software is not intended to limit the scope of the claimed invention to the transfer of information related to the generation of shipping documents.

Commonly available business applications, such as those that may be hosted on computers using the Microsoft WINDOWS™ operating system, may be written to allow third party software to be integrated with the business application. Examples of this include the ability to integrate e-mail software contacts lists within word processing software, or the ability to integrate macros within a spreadsheet application for performing routine computations. Accordingly, step 102 may install a transfer tool within a business application. This may be accomplished, for example, by providing linked code sections and adding a reference or references to the business application start-up scheme. Alternately, the transfer tool may be a separate application. Such an installation may thus include the provision of executable code portions, linked libraries, or other external references, along with the integration of references to these code or data portions within the framework of the business application. Additionally, a methodology for allowing a user to invoke the transfer tool may be added to the user interface associated with the business application.

With the transfer tool installed, a user of the tool may instantiate 104 the tool within a business application containing data to be transferred. Instantiating the transfer tool allows a user to invoke the transfer tool from within the business application, without having to execute the transfer tool each time that the business application is used, thereby reducing the effort required on the part of a user, and thereby reducing the system resources required, to transfer information. Instantiation thus may increase data flow efficiency. With the transfer tool instantiated, the user may be queried 106 to provide correlations between the manner in which information is stored in the business application, and the information required for the recipient software. Alternatively, correlations may be automatically explored by the transfer tool, such as by the application of a plurality of algorithms to the business application, wherein the plurality of algorithms are applied in accordance with the manner of data intake for the recipient software. Such algorithms may be applied in an object oriented methodology, as will be apparent to those of ordinary skill in the art. Additionally, alternatively, the user may input the location of the information to be correlated within the business application only on the first use of the transfer tool, and the correlations may then be automatically generated by the transfer tool, in accordance with the initial user instructions, upon each use of the transfer tool, if and until the user varies the information initially input.

For example, existing business applications, such as spreadsheet and database programs, are frequently used to organize information in the business environment. Both databases and spreadsheets index data contained in a specific field so that the data may be characterized based on that field, thereby allowing for the data correlation discussed hereinabove. For example, a spreadsheet may use rows and/or columns to index information, such that the contents of each field may be identified by a row and column position. Specific rows or columns may be used to hold specific information, such as a given column being used to contain street addresses for customers. Alternatively, wherein the business application is a spreadsheet type application, the telephone number of the recipient of the package may be contained within one column, or row, of the spreadsheet. Accordingly, providing the identifier of that column may provide a correlation such that the transfer tool is instructed as to the location of, for example, contact number information, wherein contact number information is desired to be transferred to the recipient software. Other information which may be desired to be exported may include, but is not limited to, recipient identification address information, tracking information, or any other information required by the waybill software. Alternatively, in a database type application, the identifier may be the name of a field under which data is stored in the database, or the name of a variable wherein variables are used for information storage, for example.

Once the transfer tool has obtained the correlation information, the transfer tool may acquire 108 the requisite information from the business application for export. The requisite recipient information may then be exported 110 to a file for later, or real time, transfer. Additionally, the requisite information may be transported to a series of discrete files, such as a single file for each customer, wherein each discrete file may be used to generate a single record, such as a single waybill, in the recipient software. Alternatively, the recipient software may be instantiated, and the data exported 110 may be directly to the recipient software. Export of the information may be element by element, recipient by recipient, for all recipients as a single data block, or by any combination of such data transfer units, for example.

The manner in which the data is to be received at the recipient software may define the manner in which the data is exported by the transfer tool. Information may be imported into recipient software through a scripted transfer of data, through the use of a vendor provided interface, through the presence of a data receipt portion of the transfer tool, or through the presence of a data receipt portion present from the use of other software, for example. Scripting presents the data in a format expected by the waybill software. For example, if the provision of a data block, followed by a tab signal, followed by the next data block, is the expected input to be received, the transfer tool may imitate those user actions by providing data delimited by tab signals. A next recipient may be signaled by an enter signal, such that the transfer tool provides an enter signal before moving to the next recipient. The transfer tool may additionally use multiple tab signals to skip fields in the waybill software data entry, or include wait states pending receipt of a signal from the waybill software before entering data, for example.

Wherein the waybill software is provided with a vendor provided interface, for example, the interface may directly import data from a file, or the transfer tool, in a predetermined format. For example, the waybill software may be provided with a data import capability based on receiving data in html or xml tagged field formats. In such circumstances, the transfer tool may generate a data page corresponding to one block of recipient information, such as a complete block of address, contact information or other information associated with the recipient of a package. The data page may then be received by the waybill software based on the vendor provided import capability, and subsequent data pages may then be discretely forwarded, thereby forming records to generate discrete waybills for each record. The recipient software may also include a capability to create a file containing recipient data, such that a recipient data file may be generated during the export process, which recipient data file may be physically or electronically transferred to, and/or normalized or reformatted by, a computer on which the recipient software is running, and which recipient data file may then imported by the recipient software. Such a transfer method may be advantageous wherein a provider of the computer on which the recipient software is resident provides restrictions regarding the operation of business applications on the computer.

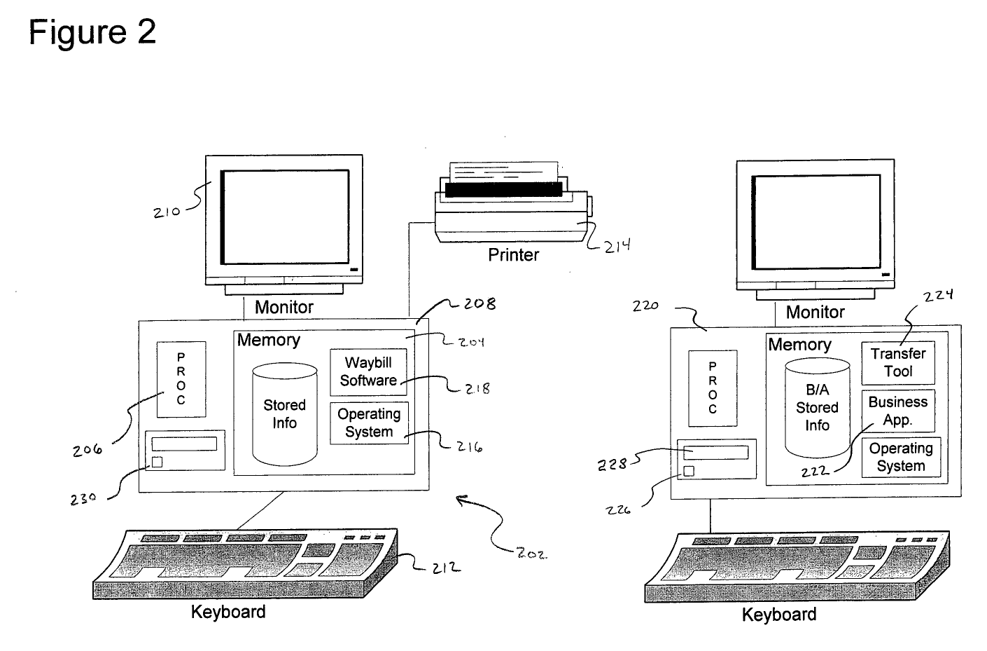

As illustrated in FIG. 2, the present invention may be embodied in a shipping document generating station 202 associated with a personal computer. A typical personal computer includes memory 204 and a processor 206 within a central processing unit 208. The central processing unit 208 may be provided with a monitor 210 and keyboard 212 to provide an interface for a user to interact with the shipping document generating station 202. The shipping document generating station 202 may also be provided with a printer 214 to allow the shipping document generating station to produce hard copies of generated shipping documents, such as waybills. Although not illustrated or specifically necessary, other devices may be incorporated with the shipping document generating station 202, such as a mouse, scanner, or network connection, or different forms of memory such as RAM, a hard drive, or removable media such as a tape drive, CD-ROM drive, or DVD drive, for example.

The shipping document generating station 202 may additionally be provided with an operating system 216 and recipient software, such as waybill software 218. Computer 220, apart, or in conjunction with, shipping document station 202, may be provided with one or more business applications 222, the transfer tool 224, and a communicator for exporting information data 226 to the shipping document generating station. The communicator 226 may simply be a floppy disk drive 228 compatible with a floppy disk drive 230 on the shipping document generating station. Alternatively, the communicator may be a tape drive, a CD ROM drive capable of recording to a CD-ROM disk, a DVD drive capable of writing to a DVD disk, or a communicable connection, such as a network communications path, allowing transfer of the data to the shipping document generating station, for example. The communicable connection may include an Internet interface, wherein both the business application computer and the shipping document generating station may have an Internet interface, such that transfer data may be communicated as an attachment to an e-mail, as html or xml information, or through ftp, for example. The communicators described are illustrative only, and are not inclusive of all methods that can be used to transfer data from the business application computer to the shipping document generating station.

Alternatively, the business application may be resident on the shipping document generating station, such that the transfer of data is internal to the computer on which the recipient software resides. Data created or utilized in the business application may be stored in the computer memory. The operating system may allow the personal computer to operate with a variety of software tools, or may be written to provide minimal functionality necessary for the waybill software and business application. More typically, the operating system may be a third party provided system, such as Microsoft WINDOWS™, Macintosh MacOS™, Unix, or Linux, for example.

Alternatively, the business application software and transfer tool may be on multiple separate computers, thereby allowing a plurality of users to generate transfer data to be communicated to the recipient software, with or without a communicable connection between the computers. Wherein no connection exists, such as wherein a shipping service requires the recipient software be hosted on a computer separate from any other business functions, a file of recipient data extracted from a business application may be stored on removable media, such as, but not limited to, a floppy disk, on the computer hosting the business application, and physically transported to and inserted into the computer hosting the recipient software. Alternately, wherein a communicable connection exists between the computer on which the business application resides and the computer on which the recipient software resides, a file may be transferred electronically between platforms.

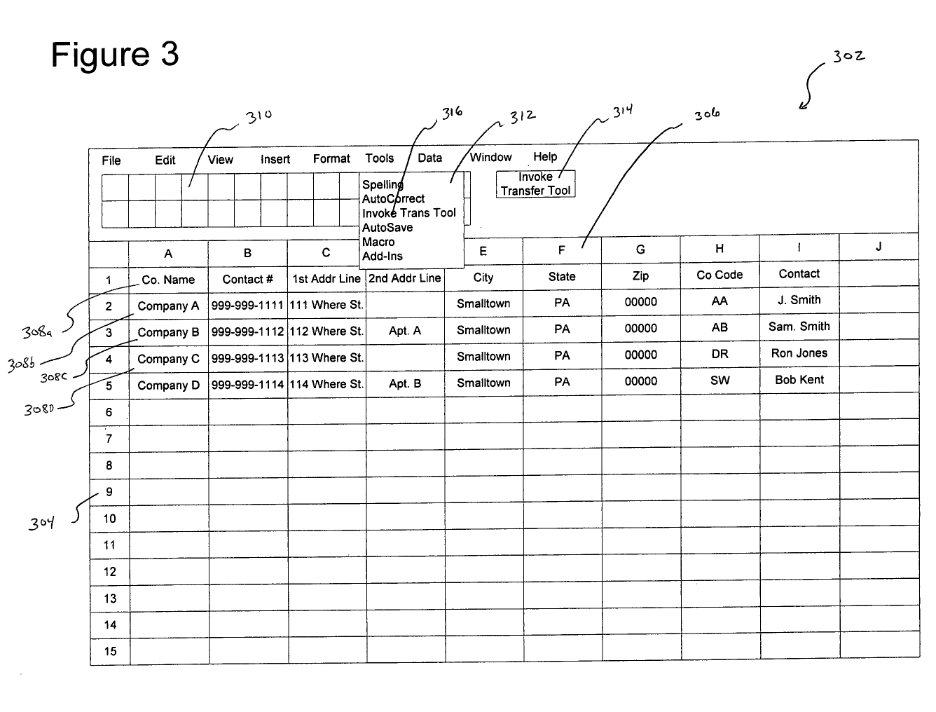

A typical business application user interface 302 of the spreadsheet type is shown in FIG. 3. Row identifiers 304 and column identifiers 306 are provided to allow identification of data contained in a cell 308 within the spreadsheet. Task buttons 310 and pull down menus 312 are provided to allow a user to invoke tools or functions within the application. The transfer tool may be integrated within the business application, such as by inclusion of a task button 314 for invoking the transfer tool, or by the inclusion of a task 316 within a pull down menu, or by an automated inclusion, for example.

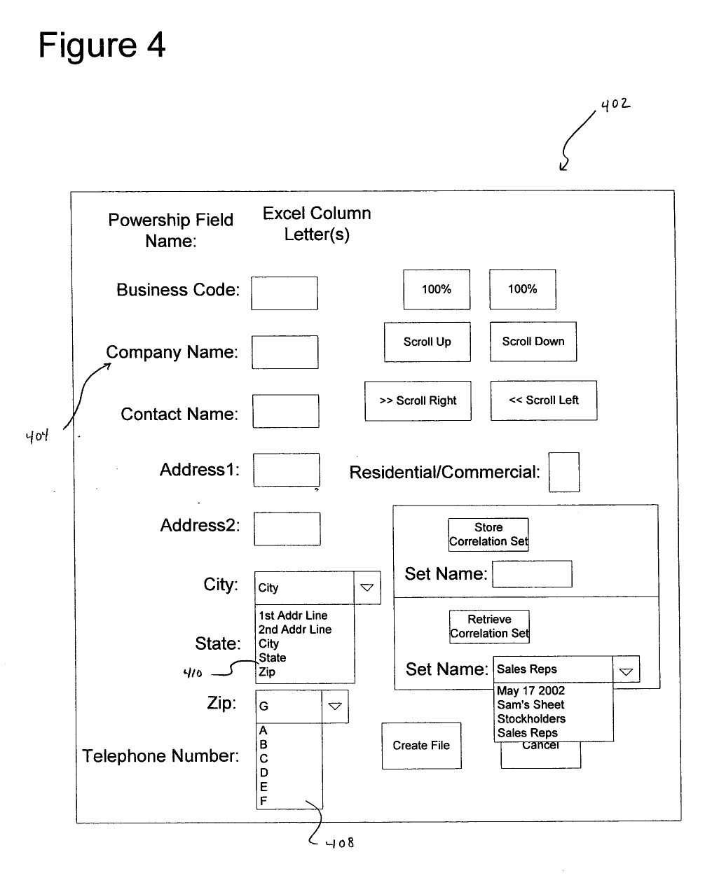

Actuation of the transfer tool, such as by task button or pull down menu, may result in the presentation of a correlation interface 402, such as shown in FIG. 4. The correlation interface 402 may prompt a user to identify correlations between fields containing required data elements associated with the business application and information required by recipient software, such as the illustrated interface for correlating recipient information between Microsoft EXCEL™ software and waybill generating software. The correlation interface may display a common name 404 for a parameter, such as “Company Name”, along with a data entry box 406 for receiving correlating information, such as a row and/or column, for the parameter. As will be apparent from the present discussion, the names of the parameters, as well as the information to be transferred, may be customized based on a specific user requirement, based on the destination of the information, or based on the business application from which the information is to be obtained, for example. The data entry boxes may be written to provide a user with pull down menus 408 identifying each of the columns in use, or with pull down menu 410 identifying each of the columns in use based on the name assigned to the column, such as the name provided in the first row of a spreadsheet. Alternatively, wherein the business application is a database type package, field names may be provided in the pull down menu boxes, for example. Additionally, different file names may be provided, wherein each file may include information regarding a particular set of, for example, a predetermined group of desired recipients.

The correlation identifiers queried in the interface shown in FIG. 4 may include identifiers for values that are required, as well as for values that are optional. In the case of required values, the transfer tool may test to ensure that all required values have been provided before starting to export data. By testing to ensure that all required correlation identifiers are present, the transfer tool can limit the likelihood of invalid, inadequate, or incomplete data reaching recipient software. For example, many package shippers will not accept a package for delivery without a contact telephone number at the recipient address. In such a situation, a correlation identifier identifying the column in a spreadsheet containing such a telephone number may be a required correlation value, such that the transfer tool would not attempt to acquire data to be transferred unless the telephone contact correlation value was present. Wherein required data is missing, the correlation may restart on the next record, and may continue moving to each record to be transferred until a record having all required information is located.

In addition to required values, optional values, such as a business code, may be incorporated. Wherein a shipper, for example, varies rates based on the type of recipient, such as commercial, residential, or other, recipient-type codes may be provided. Accordingly, the presence of the codes in the business application would allow the user to provide the codes, easing the task of generating waybills. If the codes were not known to the business application, the correlation identifier may be left blank, indicating the absence of such codes.

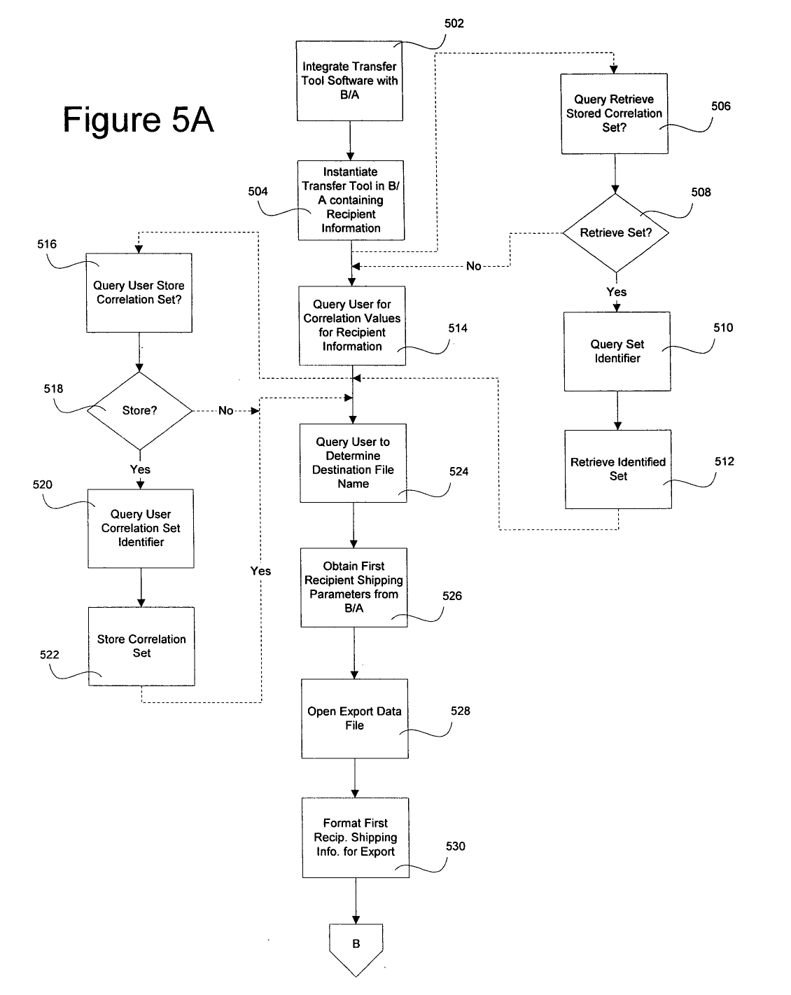

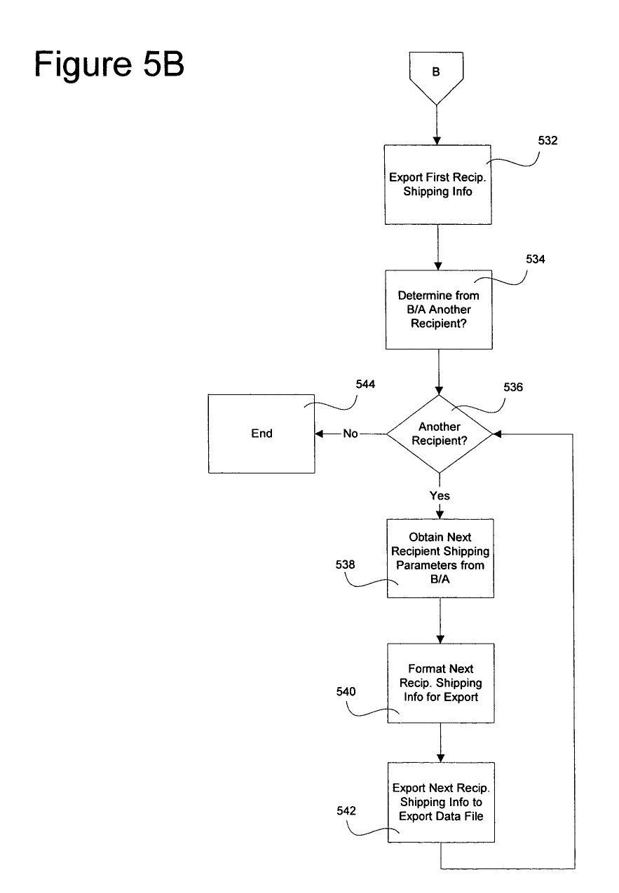

FIG. 5 shows a process embodying additional aspects of the basic transfer process, as implemented in conjunction with a spreadsheet type business application. The transfer tool software may be integrated 502 with the business application that is to be used as the source of data, as described hereinabove. Once integrated, an instance of the transfer tool can be invoked 504 in the business application, thereby allowing the provision of correlation values for identifying data to be transferred. As it may be desireable to re-use a previously provided correlation identifiers, the transfer tool may allow the user to recall a set of correlation identifiers stored on the computer. Such functionality may be implemented by first querying 506 the user as to whether the user desired to retrieve a previously stored set of correlation values. If it is determined 508 that the user desires to retrieve a stored set of correlation values, the user can be queried 810 to provide a correlation value set identifier. Such a query can simply ask the user to provide the identity of the set identifier, or can prompt the user with a list of available set identifiers, such as presented through a pull down menu or through a typical browse window, for example. The stored correlation identifiers can then be retrieved 512.

If it is determined that the user does not desire to retrieve a previously stored set of correlation values, the user can be queried 514 to provide correlation values for the present data set in use in the business application, such as through the interface shown in FIG. 3. Again, the values desired to be transferred can be selected based upon information required by the recipient program, such as waybill software. Although the interface shown in FIG. 3 shows a limited set of parameters, the interface may provide response boxes for each type of data that may be accepted by the recipient program, certain of which data types may be identified as required, or as optional, to thereby allow a user to provide whatever level of transfer that the user desired.

Once correlation identifiers are provided, the correlation identifiers may be stored for retrieval at a later date. If such functionality were implemented, the user may be queried 516 to determine 518 whether the user desires to store the entered set of correlation identifiers. If the user indicates a desire to store the correlation identifier set, the user may be queried 520 to provide a location for the set to be stored so that it can be retrieved later. Once the location has been obtained, the transfer tool may store 522 the correlation identifier set.

Once information associated with correlation identifiers has been completed, the transfer tool may instantiate the recipient software for receiving transferred information. Alternately, the transfer information may be written to a file and stored for later implementation through the recipient software.

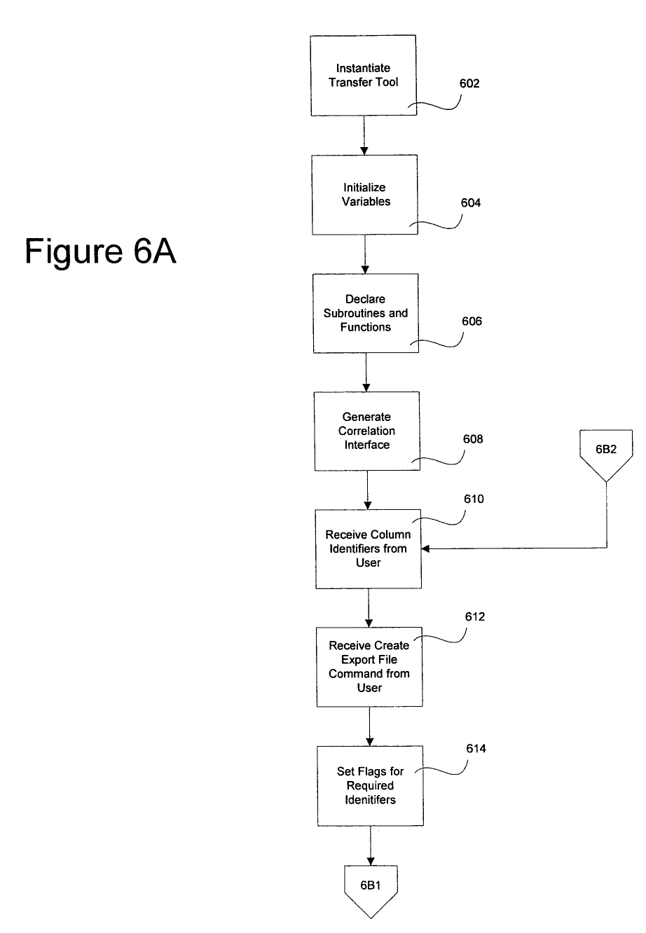

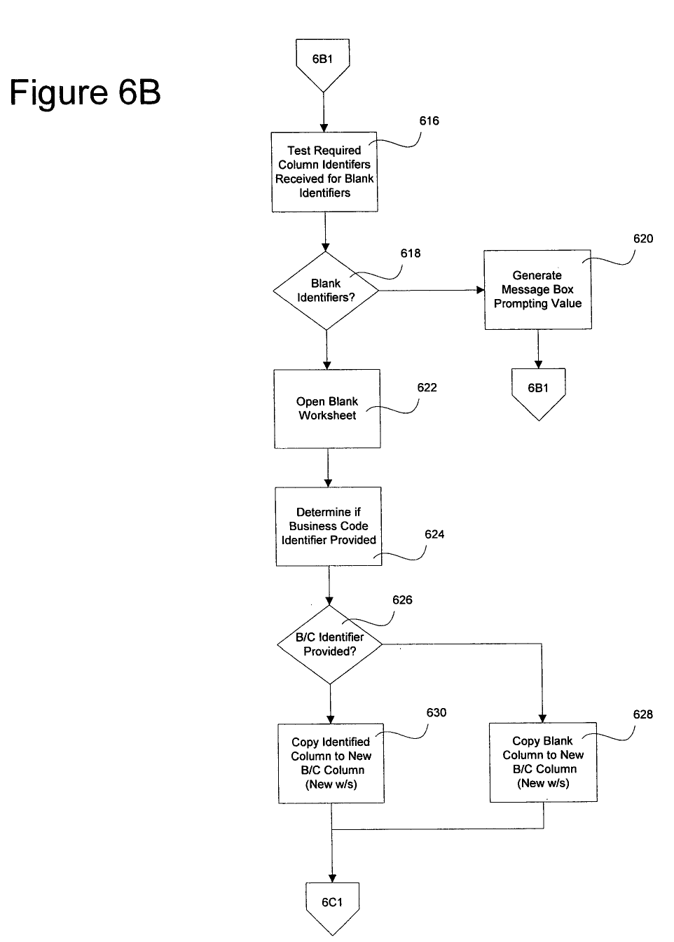

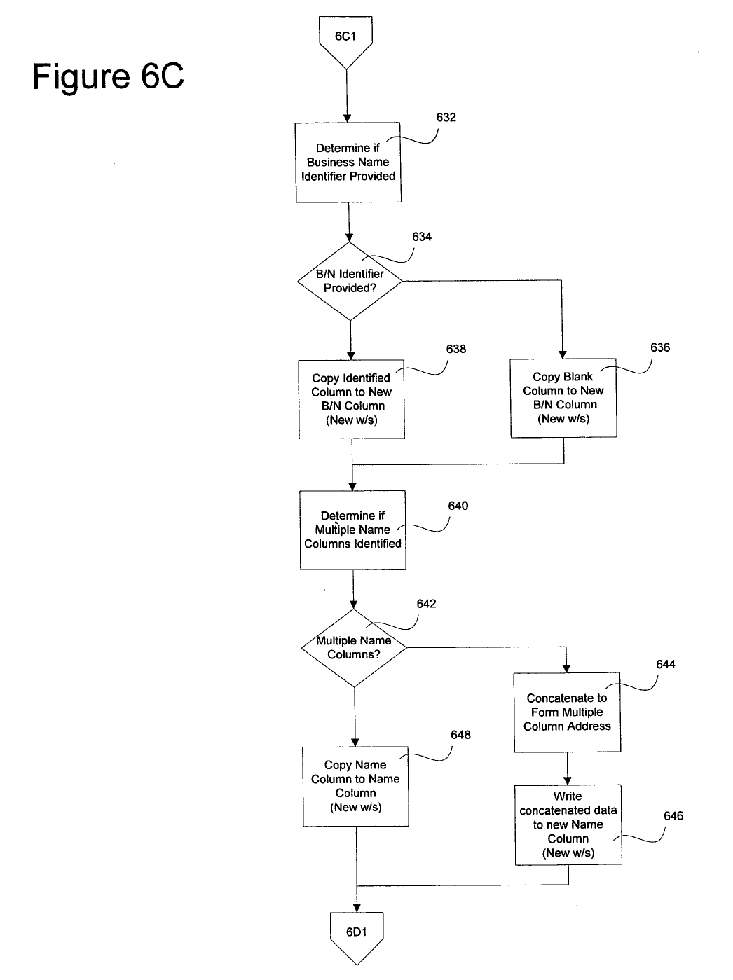

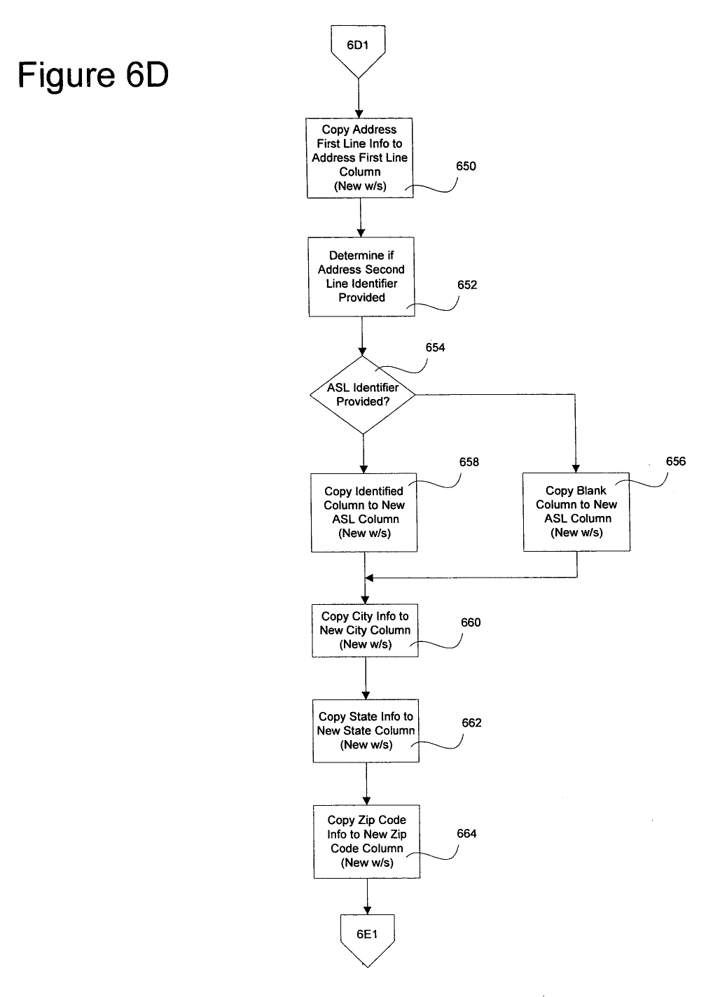

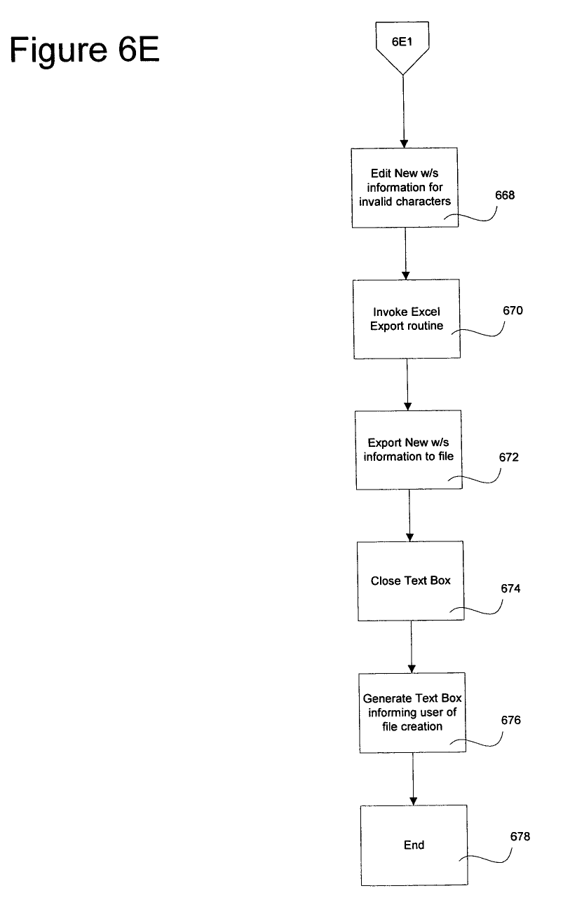

As shown in FIG. 6, the present invention may be implemented in a computer program, such as in Visual Basic, which enacts a process for transferring information between a Microsoft EXCEL™ spreadsheet type business application and Federal Express POWERSHIP shipping document generating software. Such a process, as shown, may start with the instantiation 602 of the transfer tool. In order for the program to successfully execute, the first step may be the initialization 604 of variables to be used. Once necessary variables have been initialized 604, functions and subroutines may be declared and/or defined 606. These subroutines and functions may define processes to be executed upon actuation of a displayed control, such as the “Zoom 100%” or “Cancel” buttons shown in FIG. 4, or to handle specific tasks within execution of the transfer tool program, such as the generation of correlation interface after necessary variables have been initialized, and subroutines and functions declared.

Wherein the correlation interface is also provided with commands, such as the scroll commands shown on the interface illustrated in FIG. 4, the functionality for the commands may be defined and linked to the displayed buttons. For example, the interface may be provided with zoom buttons, such that actuation of a “100% Zoom” button would result in the view/zoom parameter of the active spreadsheet being reset to 100%. The zoom value is related to the controls of the business application, and may thereby allow the use of conventions for programs operating in the Microsoft WINDOWS™ operating system, which conventions may allow common subroutines for multiple business applications. Furthermore, functionalities may be provided with programming tools provided within the business application.

A subroutine for generating the correlation interface may be called 608 by the transfer tool. The subroutine may create, for example, a textbox, by defining the number of data fields that will be transferred, creating a field name array variable having a number of elements equal to the number of data fields, and filling the values of the field name array variable with the title of each field name identifying data to be exported. A loop may then be executed creating a text entry box for each field name array variable, with the loop executing a number of times equal to the number of identified data fields to be transferred. The text entry box may also have an array variable associated therewith for receiving inputted values corresponding to the correlation identifiers, with the inputted value array variable being dimensioned such that the number of array values is equal to the number of data fields.

Instantiation of the transfer tool may cause the correlation interface to be displayed to a user, querying the user to provide correlation identifiers for the listed information types. The user may enter 610 correlation identifiers into the text entry boxes of the correlation interface, and when done, may indicate completion by actuating 612, such as an “OK” or “COMPLETE” button. Actuation of the “OK” or “COMPLETE” button may indicate the user's desire to export the data as specified at the present time.

Once a user actuates 612 an “OK” control, the program may test 616 the validity of the information by determining whether a row/column value has been provided for each data type to be transferred. Wherein a provided row/column value is blank, such as wherein no information has been entered, the program may generate 620 a message box to prompt the user to provide a value, if the blank value is necessary to the correlation. The message box may be provided with a single control to allow a user to indicate acknowledgement of the need to provide a value for the blank text box. Effectively, the program will cause a message box to pop up each time the user attempts to indicate completion of the query boxes when a query box value remains blank, or wherein a necessary box remains blank.

Optional fields may be enabled by the inclusion of flags indicating when an empty text entry box should be considered unacceptable. Flags indicating whether a correlation identifier is required or optional may be set 614 prior to testing 616 the text entry boxes for blank information. Wherein blank information is present, but an optional flag is set for that information, or a required flag information is not set for that information, the program may ignore the empty text entry box, and proceed to test 616 text entry boxes until each box has been tested, and no required/empty text entry boxes are present. Alternatively, only text entry boxes for which a required flag has been set would be tested 616, such that no optional boxes would be tested, and thus no tests would generate the popping up of a message box for an empty value in an optional text entry box.

A new worksheet may then be opened 622 to act as a storage point for the information to be exported, for example. By opening 622 a new worksheet, the information may be written to the worksheet such that sequential export of the information in the worksheet would result in an ordering of the information as written such that a recipient software package would correctly interpret the information, i.e., if the recipient software expects city, then state, then zip, but a business application ordered the information in columns for zip, then state, then city, the information would be re-ordered into the order expected by the recipient software package, for each record transferred, such as for each waybill to be generated.

The transfer tool may be enabled to accept blank columns, such as wherein information to be transferred is optional, such that when optional information is not present, a column may still be created and or filed on the new worksheet, allowing the arrangement of the information to be transferred to be kept in a standardized format whether or not the optional information is present.

The information to be exported may then be transferred to the new worksheet in an order compatible with recipient software. For illustrative purposes, the information is shown in steps 624-664 in a particular order, but it will be apparent to those of ordinary skill that this order is illustrative only. Further, information may be written to columns out of sequence. Thus, the sequence shown is merely illustrative of a possible sequence, and is not controlling as to the function of the transfer tool.

Considering business codes as an optional field, it may first be determined 624 whether a business code field has been provided. If no business code identifier has been provided, the column from which recipient software would expect to receive business code information may be filled 628 with blank information, in order to preserve a sequence of information being exported. If a business code identifier has been provided, information in the identified column may be copied 630 to the new worksheet. A similar process for other optional information may be implemented. Wherein information is considered required, columns may be copied based on the provided correlation identifier, such as in steps 660, 662, and 664.

Wherein multiple fields are used in a business application to provide information, such as wherein one field is used for a recipient's first name, and a second field is used for a recipient's last name, multiple fields may be identified in the text entry box for the information to be transferred (“recipient name”). Such information may be entered as “C:D” in the text entry box, such that correct parsing of the contained information would identify the designation of multiple columns, or a range of columns, as containing the desired information. Resolution of such a contingency is shown, wherein it may be determined 640 whether multiple name columns are present, such as through parsing of the elements constituting the information provided as a correlating identifier for “recipient name.” If it were determined 642 that multiple recipient name columns were present, the data in the multiple columns may be concatenated 644 to form recipient name values, which may then be written 646 to a single column on the new worksheet. Wherein only a single name column was identified, the contents of the name column may be copied 648 to the new name column in the new worksheet.

Once the information has been acquired from the spreadsheet and pasted into the new worksheet, the values within the new worksheet may be filtered to remove invalid characters. Invalid characters may be characters that are unacceptable to the recipient software. For example, the recipient software may require that phone numbers be provided in a continuous string of 10 numbers with no hyphens between portions of the string. Accordingly, the data in the phone number column may be tested to identify occurrences of “-”, with each occurrence being replaced by nothing, i.e., “ ”. Similar tests can be performed to identify the use of parentheses around an area code (“(“ becomes”” and “)“ also becomes ””), for example. By limiting the testing to specific columns, the testing can be constrained to prevent the unwarranted removal of characters, such as the removal of a hyphen from a contact name value.

Once the information to be transferred has been properly conditioned, the data may be transferred to an export file. The first step may be the creation through the resident operating system of the file into which data is to be exported. [Please forward remainder of subroutine “CreateExportFile”]

Once the export file has been created, the worksheet used as an interim holder for the information to be transferred may be deleted. The transfer tool may then generate a message box indicating the successful creation of the export file, and optionally may include the name and location of the export file in order to assist a user in locating the export file for transfer to recipient software.

It will be apparent to those skilled in the art that information may be transferred to the recipient software as, for example, a completed batch file or files. The batch file may include all first and last names of all desired recipients, and may be followed by a file containing street addresses, and may be followed by a file containing phone numbers, and this information may then be finally correlated upon receipt at the recipient software by the recipient software. Alternatively, the information received may be formated per recipient record, i.e. the format may be name, address, phone for recipient one, name, addrss, and phone for recipient two.

Although not shown, the present invention may be alternatively embodied in a software tool that is not integrated with a business application, but that rather that determines the name and storage location of data files associated with a business application, as well as correlation values identifying data with the data files, such that the transfer tool program can be executed with or without instantiating a copy of the business application. Using a stand alone transfer tool might require a user to close a data file from the associated business application before the information contained in the data file may be accessed, due to file protection routines within the operating systems of typical personal computers. Furthermore, the convenience of having the transfer tool integrated with the business application eases the effort required on the part of the user to identify correlation values by having instances of both the business application and the transfer tool running when the user is queried to provide the correlation values.

The previous descriptions of the present invention are provided to enable any person skilled in the art to make and use the present invention. Various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

The present invention may be embodied in other specific forms than the embodiments described above without departing from the spirit or essential attributes of the invention. Accordingly, reference should be made to the appended claims, rather than the foregoing specification, as indicating the scope of the invention.

What is claimed is:

1) A method for transferring information from a business application to a recipient, said information comprising a plurality of records associated with said business application, each record having a plurality of value types, comprising:
instantiating a transfer tool communicatively connected to said business application;
querying, by said transfer tool, of said business application for identifiers identifying value types within the information desired to be transferred to said recipient;
receiving by said transfer tool, responsively to said querying, a plurality of identifiers identifying the value types desired to be transferred to said recipient;
acquiring from said business application the value types to be transferred in accordance with said identifiers;
exporting said value types to be transferred to said recipient, wherein said recipient is allowed to generate at least one recipient address record in accordance with the transferred value types.

2) A method for transferring information according to claim 1, wherein the step of exporting said value types comprises the steps of storing said value types to removable media from said business application, said stored value types being stored to allow the recipient software to associate said stored value types with value types desired to be received by said recipient, and transferring said removable media to said recipient.

3) A method for transferring information according to claim 1, wherein the step of exporting said value types comprises transferring said value types to a remote computer on which the recipient is resident via a communicable connection.

4) A method for transferring information according to claim 3, wherein said communicable connection comprises a network connection between said business application and said recipient.

5) A method for transferring information according to claim 4, wherein said network connection comprises the Internet.

6) A method for transferring information according to claim 1, wherein said information associated with said business application comprises recipient information, said recipient information identifying recipients of shipped goods.

7) A method for transferring information according to claim 6, wherein said business application is a spreadsheet type application, and further wherein said plurality of value types associated with said plurality of records are stored in a plurality of columns, each column being associated with a particular value type, wherein said identifiers comprising column identifiers identifying columns in which values of a particular value type are stored.

8) A method for transferring information according to claim 7, wherein said step of acquiring information comprises identifying a location containing a value type desired to be transferred according to the provided identifier, and copying said value type from said location to an export file, said export file being readable by said recipient.

9) A method for transferring information according to claim 8, wherein said export file is stored on removable media.

10) A method for transferring information according to claim 1, wherein said step of querying for identifiers comprises displaying a list of particular value types desired to be transferred to the recipient in accordance with requirements of the recipient.

11) A method for transferring information according to claim 10, wherein said recipient comprises waybill generating software, and wherein said list of particular value types includes at least one value type selected from a list of value types consisting of an address, a recipient name, and a recipient phone number.

12) A method for transferring information according to claim 1, wherein said step of querying comprises the steps of receiving from a user an indication that said user desires to use a previously stored set of identifiers, and receiving from said user an identifier allowing said transfer tool to acquire said previously stored set of identifiers.

13) A method for transferring information according to claim 1, wherein said transfer tool comprises a plug-in.

14) A method for transferring information according to claim 13, wherein said business application comprises a user interface, said transfer tool displaying at least one task control on said user interface, wherein actuation of at least one of said task controls causes instantiation of said transfer tool.

15) A method for transferring information according to claim 1, wherein said transfer tool comprises a macro.

16) A method for transferring information according to claim 1, wherein at least one identifier comprises identification of at least one field identifier.

17) A computer-readable medium tangibly embodying instructions for exporting information from a business application operating on a business application computer, said information comprising a plurality of records associated with said business application, each record having a plurality of values associated with said record, said plurality of values being organized into value types, which, when executed by a computer, implement a process comprising the steps of:
instantiating a transfer tool on said business application computer, said business application computer including the business application having information to be transferred resident thereon;
querying a user for identifiers identifying value types desired to be transferred to said recipient software;
receiving from said user a plurality of identifiers identifying value types desired to be transferred to said recipient software;
acquiring from said business application the values to be transferred in accordance with said identifiers; and
exporting said values to be transferred.

18) A computer-readable medium according to claim 17, wherein the step of exporting said values comprises the steps of storing said values to removable media on said business application computer, said stored values being stored to allow the recipient software to associate said values with value types desired to be received by said recipient software, and transferring said removable media to a computer on which said recipient software is resident.

19) A computer-readable medium according to claim 17, wherein the step of exporting said values comprises transferring said values to a remote computer on which the recipient software is resident via a communicable connection, said values transferred to allow the recipient software to associate said values with value types requested by said recipient software.

20) A computer-readable medium according to claim 19, wherein said communicable connection comprises a network connection between said business application computer and said recipient software.

21) A computer-readable medium according to claim 20, wherein said network connection comprises the Internet.

22) A computer-readable medium according to claim 17, wherein said information associated with said business application comprises recipient information, said recipient information identifying desired recipients of shipped goods.

23) A computer-readable medium according to claim 22, wherein said business application is a spreadsheet application, and further wherein said plurality of values associated with said plurality of records are stored in a plurality of columns, each column associated with a particular of the value types, wherein said identifiers comprise column identifiers identifying columns in which values of a particular value type are stored.

24) A computer-readable medium according to claim 23, wherein said step of acquiring information comprises identifying a location containing a value desired to be transferred according to a provided identifier, and copying said value from said location to an export file, said export file being readable by said recipient software.

25) A computer readable medium according to claim 24, wherein said export file stores information in a tagged field format.

26) A computer-readable medium according to claim 24, wherein said export file is stored on removable media.

27) A computer-readable medium according to claim 17, wherein said step of querying a user for identifiers comprises displaying a list of particular value types desired to be transferred to recipient software in accordance with requirements of the recipient software.

28) A computer-readable medium according to claim 27, wherein said recipient software comprises waybill generating software, and wherein said list of particular value types includes at least one value type selected from a list of value types consisting of an address, a recipient name, and a recipient phone number.

29) A computer-readable medium according to claim 17, wherein said step of querying a user for identifiers further comprises the steps of receiving from said user an indication that said user desires to use a previously stored set of identifiers, and receiving from said user an identifier allowing said transfer tool to acquire said previously stored set of identifiers.

30) A computer-readable medium according to claim 17, wherein said transfer tool comprises a plug-in associated with said business application.

31) A computer-readable medium according to claim 17, wherein said transfer tool comprises a program executable as a macro within a business application.
